(19) United States
(12) Patent Application Publication
(10) Pub. No.: US 2022/0340421 A1
(43) Pub. Date: Oct. 27, 2022

(54) SYSTEMS AND METHODS FOR PRODUCING HYDROGEN AND BYPRODUCTS FROM NATURAL GAS

(71) Applicant: Bionatus, LLC, Irvine, CA (US)

(72) Inventors: Peter Capuciati, Laguna Beach, CA (US); Matthew Case, Newport Beach, CA (US)

(21) Appl. No.: 17/727,444

(22) Filed: Apr. 22, 2022

Related U.S. Application Data
(60) Provisional application No. 63/178,484, filed on Apr. 22, 2021.
(60) Provisional application No. 63/178,488, filed on Apr. 22, 2021.

(51) Int. Cl. C01B 3/24; C01B 32/15; C01B 3/50

(52) U.S. Cl. CPC C01B 3/24; C01B 32/15; C01B 3/50; C01B 2203/0211; C01B 2203/1241; C01B 2203/066

(57) ABSTRACT

Producing hydrogen and carbon from hydrocarbons in a single-step process is described. A feedstock including natural gas or other light (e.g., <C5) hydrocarbons is introduced to a plasma reformer. The plasma reformer typically includes a non-thermal plasma. The plasma separates hydrogen from the carbon of the feedstock, yielding H2 and carbon black. The carbon is separated from the H2, and the H2 is further used as fuel (e.g., generating electricity via fuel cell) either contemporaneously or at a later time, stored, pressurized, or dispensed to a vehicle. Excess electricity generated form the H2 is stored in a battery, and excess is either stored or pressurized. Carbon black is further condensed to reduce volume for storage or transport.

This application claims the benefit of priority to U.S. Provisional Patent No. 63/178,484 filed Apr. 22, 2021 and U.S. Provisional Patent No. 63/178,488 filed Apr. 22, 2021, both of which are incorporated by reference in their entirety herein.

### FIELD OF THE INVENTION

The field of the invention is clean energy technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Over the last couple of decades, the fight against climate change has gained significant urgency. This urgency has in turn inspired technical innovations that attempt to tackle the problem from different approaches.

One approach has been the development of electric vehicles. Electric vehicles have soared in popularity over the last decade, as battery technology has made viable designs possible. However, the technology still has significant hurdles to overcome before the internal combustion engine is rendered obsolete. On the production side, the materials required for battery production are very finite and may not support a truly global amount of vehicles. On the user side, charging times and range anxiety prevent electric vehicles from truly replacing traditional internal combustion engine-based vehicles.

Another approach has been the use of hydrogen as a fuel. Since the only byproduct of using hydrogen as a fuel is water, it is a very promising approach to environmentally-friendly energy. However, the production of hydrogen for use as fuel requires a great deal of energy. Moreover, hydrogen can be highly explosive, making the distribution of hydrogen a dangerous, costly process.

Hydrogen fuel cell vehicles have advantages over electric vehicles such as faster charging and a greatly-reduced battery size. Without the challenges associated with the generation and distribution of hydrogen, hydrogen fuel cell vehicles could surpass electric vehicles as a replacement for the traditional internal combustion engine.

Others have attempted to solve the challenge of generating hydrogen from natural gas. For example, the process for creating high-purity carbon black from natural gas by Monolith Materials, Inc. of Lincoln, Nebraska also results in hydrogen as a product. However, the facility required for this process is large and as such the problems associated with storage and distribution of hydrogen remain.

It is known to use a plasma reformer (plasmatron) to produce hydrocarbon-rich gas (50-75%) from natural gas (mostly methane), and then passing the hydrocarbon-rich gas to a fuel cell to produce electricity. See U.S. Pat. No. 5,409,784 (Bromberg, 1995), and L. Bromberg, D. R. Cohn and A. Rabinovich, “Plasma Reformer-Fuel Cell System For Decentralized Power Applications”, Int. J. Hydrogen Energy Vol 22., No. 1, pp 83094 (1997). Fuel cells combine the hydrogen-rich gas with oxygen from the air generate electricity and produce water. Suitable fuel cells are reported to include molten carbonate fuel cells (MCFC), solid oxide fuel cells (SOFC), and in phosphoric acid fuel cells (PAFC). This same prior art also teaches that the process can be utilized in a motor vehicle.

These and all other extrinsic materials are incorporated herein by reference in their entirety. Where a definition or use of a term in a reference that is incorporated by reference is inconsistent or contrary to the definition of that term provided herein, the definition of that term provided herein is deemed to be controlling.

Cross-reference is made to U.S. Provisional Patent. No. 63/178,449 filed Apr. 22, 2021, U.S. Provisional Patent No. 63/178,459 filed Apr. 22, 2021, U.S. Provisional Patent No. 63/178,464 filed Apr. 22, 2021, U.S Provisional Patent No. 63/178,476 filed Apr. 22, 2021, U.S. Provisional Patent No. 63/178,478 filed Apr. 22, 2021, U.S. Provisional Patent No. 63/178,462 filed Apr. 22, 2021, U.S. Provisional Patent No. 63/178,470 filed Apr. 22, 2021, and U.S. Provisional Patent No. 63/178,474 filed Apr. 22, 2021, each of which is copending and filed by Applicant.

One difficulty with most of Bromberg's devices and methods is that the hydrogen-rich gas comprises 25-75% H2 and 25-40% carbon monoxide (CO). The CO can be converted into carbon dioxide (CO2) by injection of steam, which can interfere with operation of the fuel cells. Bromberg does teach an alternative embodiment, in which a plasmatron can be operated in a water-free, an oxygen deficient manner. In that embodiment, thermal decomposition eliminates production of both carbon monoxide (CO) and carbon dioxide (CO2), and produces mostly pure hydrogen and carbon (soot). A remaining problem, however, is that at much reduced efficiencies (e.g., 30% for CH4) due to the high temperatures (1,000°-3,000° C.) required.

What is needed are systems and methods in which CH4, other light hydrocarbons, or mixtures such as natural gas, can be used to efficiently produce electricity in situ, without significant release carbonaceous gasses into the atmosphere.

### SUMMARY OF THE INVENTION

Systems, methods, and devices for producing hydrogen and carbon from a hydrocarbon feedstock are described. A cost-effective method of producing H2 and carbon includes introducing a feedstock to a reformer. The reformer uses the feedstock to concurrently separate H and C from the feedstock, and H2 produced from the reformer is separated from carbon. The feedstock is typically natural gas or another hydrocarbon with no more than 5 carbon, whether alone or in combination with other hydrocarbons or gasses (e.g., noble gases, nitrogen, oxygen etc.). The reformer generally uses a plasma to energize and break H and C bonds in a hydrocarbon, in preferred embodiments a non-thermal plasma, DBD plasma, or microwave plasma, either alone or in combination.

The produced H2 and the carbon are generally stored, as the separated carbon is favorably found in nanoparticle form. Generally the feedstock (e.g., natural gas) is stored distal to the reformer, for example at least 5, 10, 20, or 50 meters from the reformer. Once the H2 is produced and separated from carbon, it is conveyed to a pressurization, storage, or distribution point, in some embodiments proximal (within 4, 3, 2, or 1 meters) to the reformer, for example when the H2 is subsequently or contemporaneously dispensed to a fuel cell powered vehicle. Viewed from another perspective, in some embodiments the produced H2 is pressurized, either to aid in storage or transport. Likewise, in some embodiments the produced carbon is compressed or compacted to aid in storage or transport. In preferred embodiments, at least 20% of the carbon is in a nanostructure form. It should be appreciated that through use of such a system, carbon is favorably captured in a solid form rather than released as a gaseous byproduct.

Vehicles receiving the produced H2, for transport, as fuel, or both, include California DMV class vehicles, locomotives, propeller vehicles, turbine vehicles, water crafts, or construction vehicles.

In some embodiments a portion of the produced H2 is used by a fuel cell to produce electricity. For example, the produced electricity is used to power the reformer, equipment used to store the H2 or carbon, equipment used to condense the H2 or carbon, or equipment used to dispense the H2, or combinations thereof. For example, it is contemplated that such a reformer system, once activated, could produce enough H2 to power the reformer itself as well as all operations required to dispense the produced H2, with our without the aid of grid or renewable power source.

The produced H2 can also be used as a fuel contemporaneous to separating the produced H2. In such cases, the H2 is typically used as a fuel in proximity to production of the H2. The rate of production of H2 can further be altered (e.g., increased, decreased, paused, etc.) according to present or expected demand for electricity derived from the H2. Such electricity demand can come from any one of an electricity grid, an electricity storage capacity, an electrically operated device, an electronic system, a plasma device, or combinations thereof.

In some embodiments or occasions, for example when H2 is not in demand, the H2 fuel is used to generate electricity or otherwise stored in a battery, whether chemical or mechanical. For example, a fuel cell can be used to convert and store excess H2 fuel as electricity, which may be easier to transport or distribute than the H2 fuel. Likewise, excess H2 fuel can be stored in a pressurized tank for later use, dispensing, or transport. Generally, such described methods of producing H2 fuel is localized to one of a building (e.g., commercial, residential, industrial, utility charge, fuel station, power plant, etc.) or a vehicle.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts a system of the inventive subject matter.

FIG. 2 depicts applications of a system of the inventive subject matter.

FIG. 3 depicts another application of a system of the inventive subject matter.

FIG. 4 depicts a prior art plasma device.

FIG. 5 depicts another prior art plasma device.

FIG. 6 depicts another system of the inventive subject matter.

FIG. 7 depicts a flow chart of a process of the inventive subject matter.

FIG. 8 depicts yet another application of a system of the inventive subject matter.

FIG. 9 depicts still another application of a system of the inventive subject matter.

FIG. 10 depicts yet another application of a system of the inventive subject matter.

FIG. 11 depicts another application of a system of the inventive subject matter.

FIG. 12 depicts a further application of a system of the inventive subject matter.

FIG. 13 depicts still another application of a system of the inventive subject matter.

### DETAILED DESCRIPTION

It has now been discovered that this can be accomplished using a non-thermal plasma to reform the feed gas into substantially pure (≤5% wt/wt impurities) H2 and carbon, and feeding the H2 into fuel cells to produce the electricity.

The nomenclature for nonthermal plasma (“NTP”) found in the scientific literature is varied. In some cases, the plasma is referred to by the specific technology used to generate it (“gliding arc”, “plasma pencil”, “plasma needle”, “plasma jet”, “dielectric barrier discharge”, “Piezoelectric direct discharge plasma”, etc.), while other names are more generally descriptive, based on the characteristics of the plasma generated (“one atmosphere uniform glow discharge plasma”, “atmospheric plasma”, “ambient pressure nonthermal discharges”, “non-equilibrium atmospheric pressure plasmas”, etc.). The two features which distinguish NTP from other mature, industrially applied plasma technologies, is that they are 1) nonthermal and 2) operate at or near atmospheric pressure.

One should appreciate that the disclosed techniques provide many advantageous technical effects including simplifying clean energy production and use.

Systems, methods, and devices providing cost-effective production of H2 and carbon are disclosed. A feedstock is introduced to a reformer. The reformer is used to concurrently separate H and C from the feedstock. The H is separated from the carbon, in the form of H2. The feedstock is preferably natural gas, a light hydrocarbon (e.g., less than C5) or other hydrocarbon. The reformer typically uses one or more plasmas (e.g., hybrid plasma) or one or more plasma devices. In some embodiments, the plasma is a non-thermal plasma.

In some embodiments, the H2 or the carbon, or both, are further stored. Further, a feedstock storage can be proximal to avoid long distance transmission issues, or distal to the reformer and supplied by a service line. Likewise, while the H2 can be stored on site (e.g., proximal to the reformer) it can also be stored closer to a distribution point, or supplied directly to the distribution point without intermediate storage. The H2 can also be pressurized, for example when prepared for container shipment or direct supply to vehicles.

Likewise, for ease of transport, maintenance, or further processing, the produced carbon can also be compressed. In some embodiments, at least 20% of the produced carbon is in a nanostructure form. The nanostructure carbon can be further separated from the produced carbon for further processing or use.

Where the H2 is supplied to a vehicle (e.g., after compression), contemplated vehicles include California DMV class vehicles, a locomotive, a propeller vehicle, a turbine vehicle, a sea craft, a construction vehicle, or a spacecraft.

Favorably, a portion of the produced H2 is further stored for use or used by a fuel cell to produce electricity, for example proximal to the reformer. For example, the electricity is used to power at least one of the reformer, storing the H2 or carbon, or a step of dispensing the H2, or otherwise operating related devices or equipment. Likewise, electricity can further be stored in a battery (e.g., proximal to reformer) or otherwise distributed directly to a number of use cases, for example powering neighbor structures or equipment, or supplied to electrified vehicles.

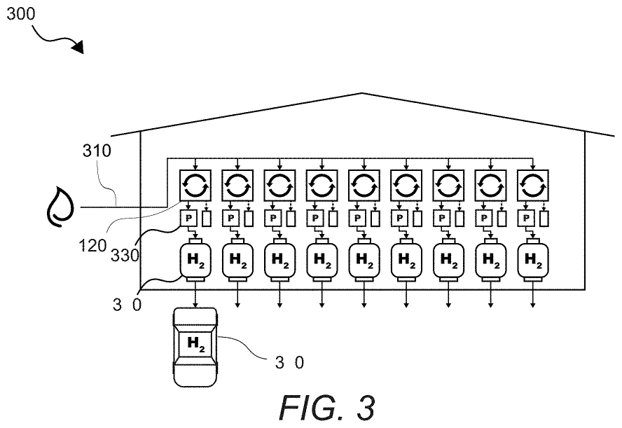

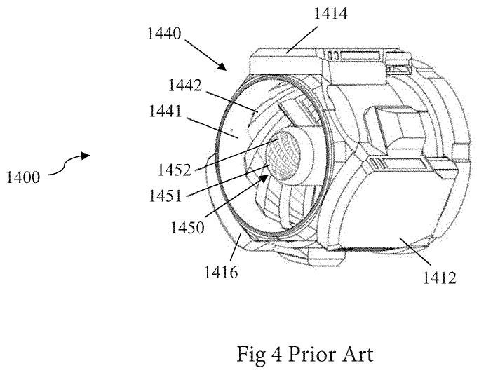

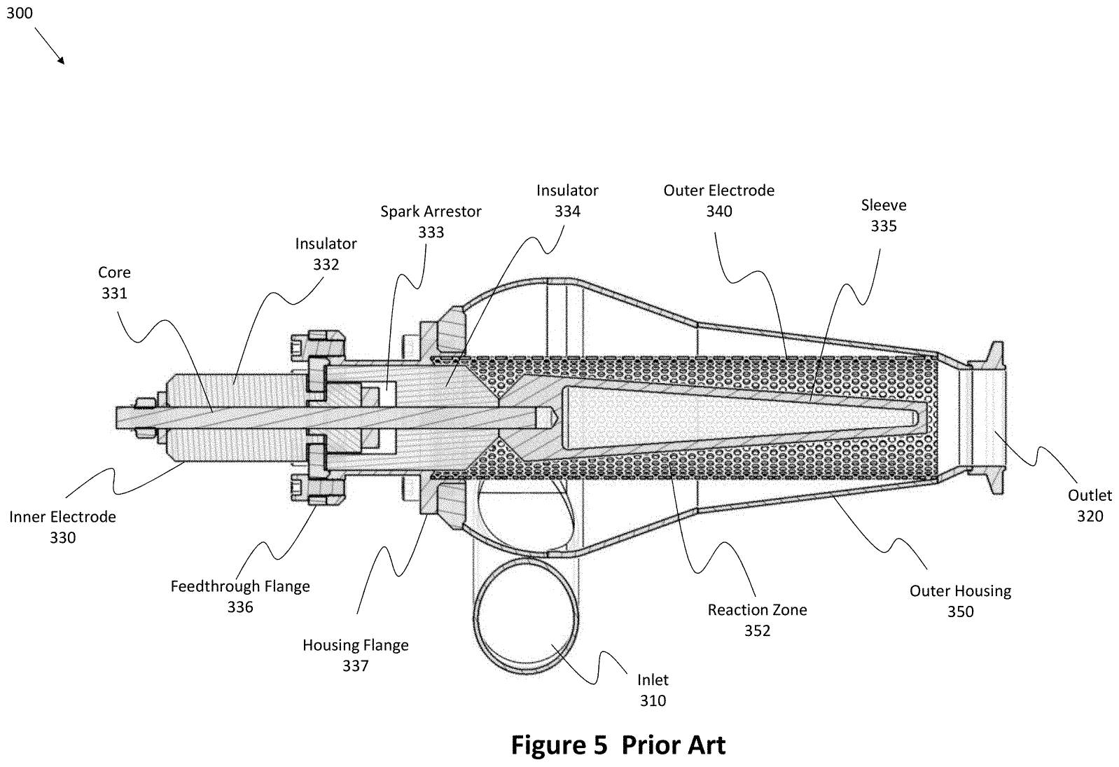

Reformers of the inventive subject matter typically include plasma devices, for example those described in U.S. Pat. No. 10,293,303 to Hill or U.S. Pat. No. 10,947,933 to Hill. While such devices are primarily taught to treat intake flows or exhaust flows to favorably increase combustion efficiency or otherwise reduce harmful combustion emissions, surprisingly such devices are unexpectedly effective at reforming a hydrocarbons to separate hydrogen from carbon and produce nearly pure H2 and carbon (e.g., carbon black) at a high rate of efficiency. See '303 Patent at FIG. 14B (included as FIG. 4 herein) or '933 Patent at FIG. 3 (included as FIG. 5 herein) for examples of such devices. Such devices can be used stand-alone or arranged in a serial or parallel fashion, either linearly, recursively, or nested, etc.

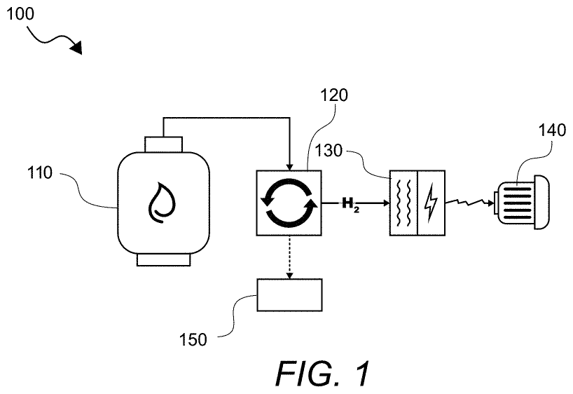

FIG. 1 depicts system 100 of the inventive subject matter. Feedstock in the form of natural gas is supplied to plasma reformer 120 to produce (nearly) pure H2 and carbon (e.g., carbon black). The H2 and carbon are separated and diverted, with carbon sent to receptacle 150 for further processing (e.g., compression, sorting nanostructure carbon, etc.) while the H2 is sent to fuel cell 130. Fuel cell 130 uses the H2 to produce electricity, which is then sent to electric device or motor 140. H2 can further be diverted for pressurization or to a tank for storage. Likewise, electricity generated from the fuel cell is used to power the reformer or diverted to a battery for storage.

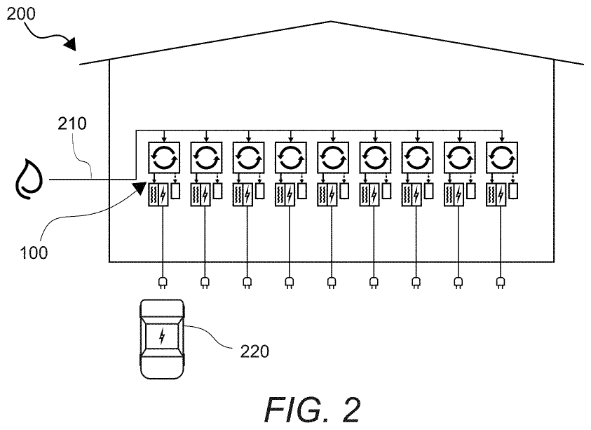

FIG. 2 depicts system 200 of the inventive subject matter. In this use case, feedstock in the form of natural gas 210 is supplied to a series of plasma reformers of a plurality of systems 100. Each reformer in turn separates (nearly) pure H2 from carbon and routes the H2 to a fuel cell for electricity production as in system 100. The electricity is then either stored or routed to charge an electric vehicle. In some embodiments, the natural gas is reformed to hydrogen and used to produce electricity upon demand, for example when an electric vehicle pulls into a charging stall or connects with the system to charge.

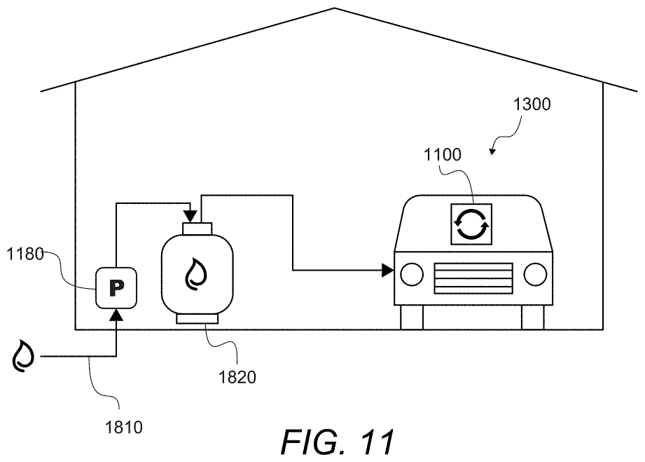

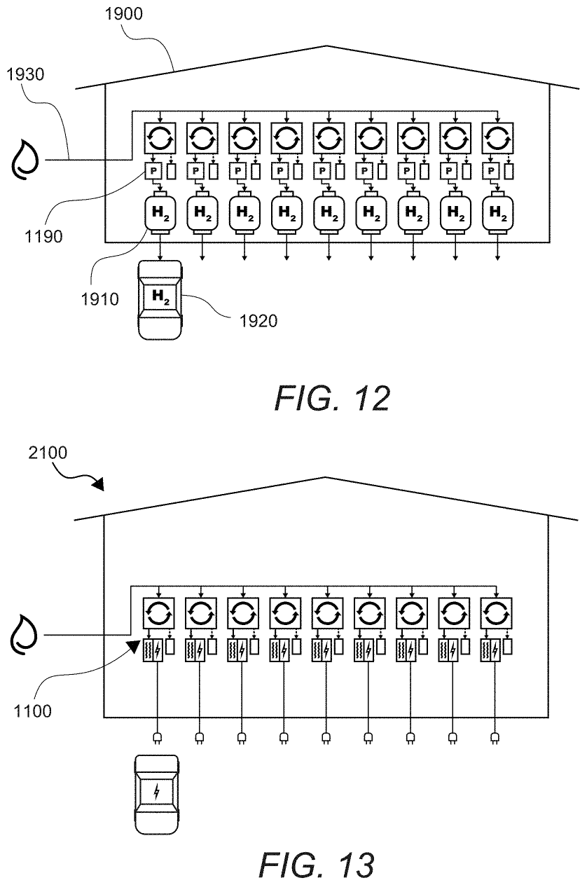

FIG. 3 depicts system 300 of the inventive subject matter. In this use case, feedstock in the form of natural gas 310 is supplied to a series of plasma reformers 120. Each reformer 120 in turn separates (nearly) pure H2 from carbon, routes the H2 to pressurizers 330 for storage in tanks 340, and supplies the pressurized H2 to vehicle 350 powered by a fuel cell. For further examples, see FIGS. 11 and 12 below.

One should appreciate that the disclosed techniques provide many advantageous technical effects including simplifying clean energy production and use.

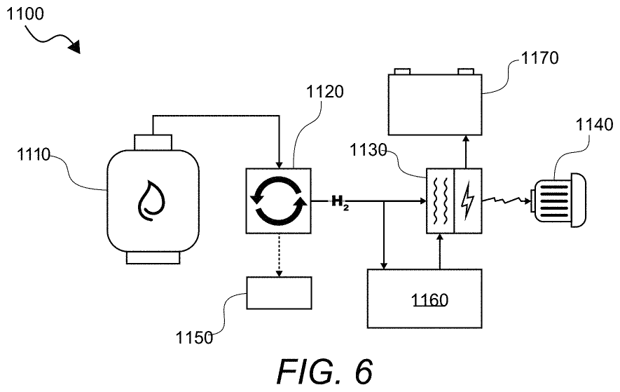

FIG. 6 shows a system 1100 of the inventive subject matter in isolation. The system 1100 includes a feedstock (e.g., natural gas or other light hydrocarbon) source 1110 that is fluidly coupled to a reformer 1120.

The feedstock source 1110 can be a feedstock supply line leading to the location of the system 1100 from a supplier (e.g., a natural gas line to a location). In embodiments, the feedstock source 1110 can be a tank or reservoir of feedstock.

In the discussion herein, references are made to the use of natural gas as an example of a suitable feedstock. However, it is understood that other suitable light hydrocarbons could be used.

Reformer 1120 used in the systems and methods of the inventive subject matter typically include cold plasma reformers that can be used in this fashion, for example those described in U.S. Pat. No. 10,293,303 to Hill or U.S. Pat. No. 10,947,933 to Hill, which are incorporated in their entirety herein by reference. While such devices are primarily taught to treat intake flows or exhaust flows to increase combustion efficiency or otherwise reduce harmful combustion emissions, surprisingly such devices are unexpectedly effective at reforming hydrocarbons to separate hydrogen from carbon and produce nearly pure H2 and carbon (e.g., carbon black) at a high rate of efficiency without pollutants. See '303 Patent at FIG. 14B or '933 Patent at FIG. 3 for examples of such devices. Such devices can be used stand-alone or arranged in a serial or parallel fashion, either linearly, recursively, or nested, etc. FIG. 14B of the '303 patent is reproduced here as FIG. 4 and FIG. 3 of the '933 patent is reproduced here as FIG. 5.

The reformer 1120 is the fluidly coupled with at least one fuel cell 1130, to which it supplies hydrogen as fuel. The fuel cell(s) 1130 use the supplied hydrogen to generate electricity. In embodiments, the fuel cell(s) 1130 can be electrically coupled with an electric load 1140 (here shown as an electric motor 1140) and the electricity produced can be used to power the load 1140. As seen in FIG. 6, the system 1100 also includes a carbon storage container 1150 that is fluidly coupled with the reformer 1120 to store carbon byproduct. The steps of the methods of the inventive subject matter will be discussed in further detail below.

Contemplated loads 1140 that provide a demand for electricity include an electricity grid, an electricity storage capacity (which could include a battery 1170), an electronically operated device, an electronic system, a plasma device, a vehicle, a building, etc.

The system 1100 of FIG. 6 also includes an H2 storage tank 1160 that can be used to store hydrogen produced by the reformer 1120. The storage tank 1160 can then be used to supply the stored hydrogen to the fuel cell 1130.

In embodiments of the inventive subject matter, the system 1100 includes a filter (such a carbon separator) coupled with the output end of the reformer 1120. An example of a suitable filter is a cyclone type filter, though other suitable filters are also contemplated. The filter separates the hydrogen produced by the reformer 1120 from the carbon byproduct. The carbon byproduct is then directed to the carbon storage container 1150.

In embodiments of the inventive subject matter, the system 1100 can also include a battery 1170 used to store electric energy from the fuel cells. The electricity stored by batter 1170 can be used to store only excess energy, or can be a primary recipient of all electricity for later distribution. The battery 1170 can, in embodiments, also provide electricity to the load 1140.

In embodiments of the inventive subject matter, the system 1100 includes a filter (such a carbon separator) coupled with the output end of the reformer 1120. An example of a suitable filter is a cyclone type filter, though other suitable filters are also contemplated. The filter separates the hydrogen produced by the reformer 1120 from the carbon byproduct. The carbon byproduct is then directed to the carbon storage container 1150.

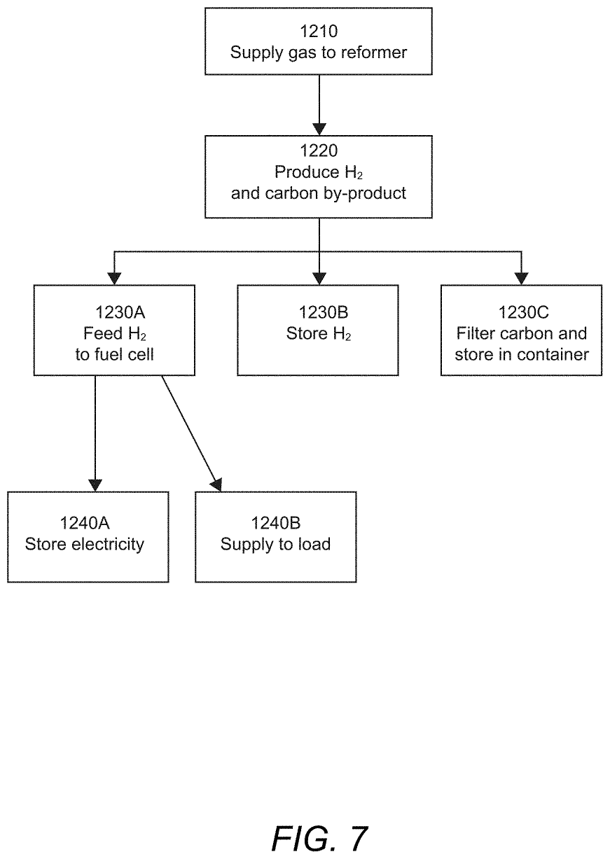

FIG. 7 provides a flowchart of the processes executed according to embodiments of the inventive subject matter.

At step 1210, the feedstock source 1110 supplies natural gas to the reformer 1120.

At step 1220, the reformer 1120 generates hydrogen from the natural gas, with carbon as a byproduct. One or more of the components of the system 1100 can be controlled by a computer and/or have a programmable on-board processor. Thus, for example, the production of hydrogen at step 1220 can be controlled based on a demand for electricity at any particular moment. If a demand for electricity increases, the reformer 1120 can receive a command to increase hydrogen production accordingly. Likewise, for a drop in demand, the reformer 1120 can receive a command to decrease the production of hydrogen.

At step 1230A, the hydrogen is fed to the fuel cell(s) 1130 for conversion to fuel. Because the production of hydrogen can be controlled by the reformer 1120, the supply of hydrogen to the fuel cell(s) 1130 can be considered to be contemporaneous for their use as fuel at step 1230A.

Having produced the electricity at step 1230A, the system 1100 can then store the electricity in the battery 1170 at step 1240A or provide it to a load 1140 for immediate use at step 1240B.

At step 1230B, the hydrogen produced by the reformer 1120 can be stored for later use in tank 1160.

The carbon byproduct is filtered out and stored in the container 1150 at step 1230C.

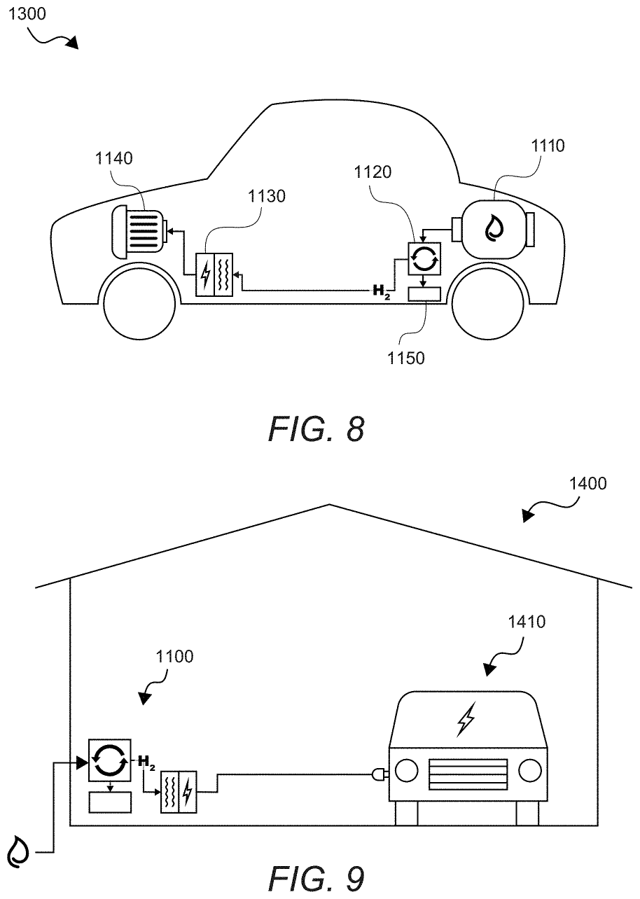

In embodiments of the inventive subject matter, some or all of the system 1100 can be internal to or localized in a building or a vehicle. FIG. 8 shows an example of the system 1100 internal to an automobile 1300. The system 1100 of FIG. 8 does not show all of the components of FIG. 6, but it is understood that this system can also include a tank 1160 and/or a battery 1170.

In vehicle applications, the source 1110 of FIG. 6 will be a reservoir 1110 used to store the feedstock (e.g., natural gas). In these applications, the vehicle can be refueled by a source that feeds feedstock into the reservoir 1110.

FIG. 9 shows the system 1100 deployed in a house 1400, and used to charge an electric car 1410.

Contemplated vehicles can include a California DMV class vehicle, a locomotive, a propeller vehicle, a turbine vehicle, a sea craft, or a construction vehicle.

Contemplated buildings can include commercial, residential, industrial, or utility buildings or structures.

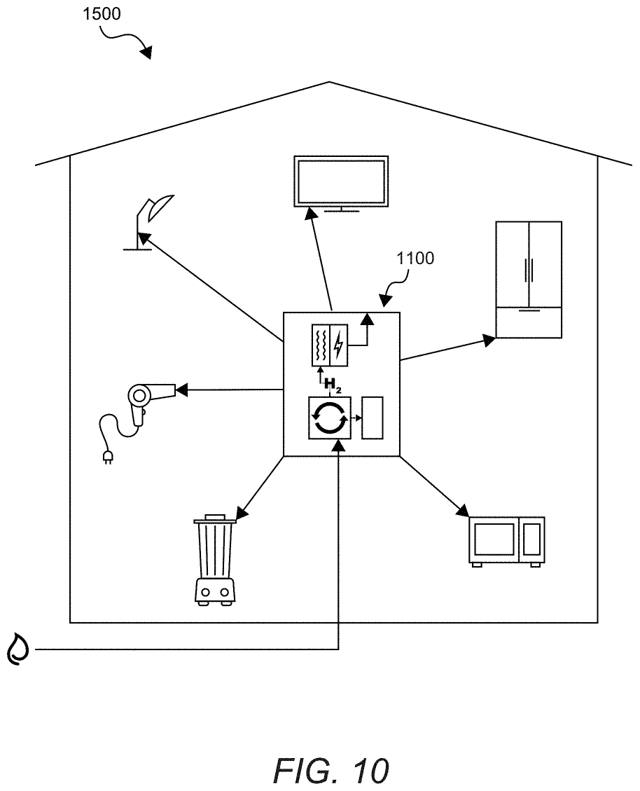

FIG. 10 shows the system 1100 deployed in a house 1500, where it used to generate electricity for a plurality of home appliances.

In embodiments of the inventive subject matter, the system 1100 can include a pump 1180 that can be used to store gasses under pressure. For example, FIG. 11 illustrates an embodiment where natural gas from gas line 1810 is pumped into reservoir 1820, which is then used to refuel vehicle 1300 (which includes system 1100 to convert the natural gas into electricity as discussed above). In other embodiments, the pump can feed directly into the intake of the vehicle 1300 without an intermediary tank 1820, though this may result in longer refuel times.

FIG. 12 illustrates an embodiment of a hydrogen refuel station 1900 that can be used with existing hydrogen-powered automobiles that incorporates a pump 1190 after the reformer 1120 such that the hydrogen is stored at an appropriate pressure in tank 1920, ready for dispensing into vehicle 1920. In the embodiment of FIG. 12, the feedstock is provided via gas line 1930 and converted into hydrogen at the location.

FIG. 13 shows a charging station for electric vehicles that incorporate a plurality of stations each having system 2100. In these cases, the natural gas line supplies the feedstock necessary to generate hydrogen and then electricity at the location.

The description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The above discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A cost-effective method of producing H2 and carbon, comprising:
introducing a feedstock to a reformer;
using the reformer to concurrently separate H and C from the feedstock; and
separating produced H2 and carbon.

2. The method of claim 1, wherein the feedstock comprises natural gas or another hydrocarbon with no more than 5 carbon.

2. The method of claim 1, wherein the reformer uses a plasma.

3. The method of claim 2, wherein the plasma is a non-thermal plasma.

4. The method of claim 1, further comprising the step of storing the H2 and the carbon.

5. The method of claim 1, wherein a feedstock storage is distal to the reformer.

6. The method of claim 1, further comprising the step of conveying the H2 to a storage or a distribution point.

7. The method of claim 6, wherein the storage or distribution point is proximal to the reformer.

8. The method of claim 1, further comprising the step of pressurizing the produced H2.

9. The method of claim 1, further comprising the step of compressing the produced carbon.

10. The method of claim 1, wherein at least 20% of the carbon is in a nanostructure form.

11. The method of claim 6, wherein the H2 is dispensed to a vehicle.

12. The method of claim 11, wherein the vehicle is one of a California DMV class vehicle, a locomotive, a propeller vehicle, a turbine vehicle, a sea craft, or a construction vehicle.

13. The method of claim 1, wherein a portion of the H2 is used by a fuel cell to produce electricity.

14. The method of claim 13, wherein the electricity is used to power at least one of the reformer, a step of storing the H2 or carbon, a step of condensing the H2 or carbon, or a step of dispensing the H2.

15. The method of claim 1, further comprising a step of providing H2 for use as a fuel contemporaneous to separating the produced H2.

16. The method of claim 15, wherein the H2 is used as a fuel in proximity to production of the H2.

17. The method of claim 15, further comprising a step of altering a rate of production of H2 according to a demand for electricity derived from the fuel.

18. The method of claim 17, wherein the electricity demand is from one of an electricity grid, an electricity storage capacity, an electrically operated device, an electronic system, or a plasma device.

19. The method of claim 15, further comprising the step of using the fuel to generate electricity, and storing unused electricity in a battery.

20. The method of claim 15, further comprising the step of storing excess fuel in a pressurized tank.

21. The method of claim 15, further comprising using a fuel cell to convert and store excess fuel as electricity.

22. The method of claim 1, wherein the method is localized to one of a building or a vehicle.

23. The method of claim 22, wherein the building is one of commercial, residential, industrial, or utility.
